(19) United States
(12) Patent Application Publication
(10) Pub. No.: US 2010/0209634 A1
(43) Pub. Date: Aug. 19, 2010

(54) BLOW MOLDING FOR CONTAINER EQUIPPED WITH DIVIDED RECEPTACLE

(75) Inventors: Yang Soo Kim, Gyeonggi-do (KR); Boon Ja Kwon, Gyeonggi-do (KR)

Correspondence Address: SHERR & VAUGHN, PLLC, 620 HERNDON PARKWAY, SUITE 320, HERNDON, VA, 20170, US

(73) Assignee: Cool Tech Co., Ltd., Bucheon, Gyeonggi-do (KR)

(21) Appl. No.: 12/674,309

(22) PCT Filed: Sep. 3, 2008
(86) PCT No.: PCT/KR08/05186

§ 371 Date: Feb. 19, 2010

(30) Foreign Application Priority Data
Sep. 5, 2007 (KR) 10-2007-0089788

(51) Int. Cl. B32B 1/06; B29C 49/18

(52) U.S. Cl. 428/34.1; 264/529; 264/526

(57) ABSTRACT

A blow molding method for manufacturing a container equipped with a receptacle divided by a partition wall, wherein the partition wall is formed in a preform, which is in general fabricated by injection molding, the preform is arranged in a blow molding die, and blow molding is performed to the preform in a molding process which is conducted two times, so that a container product has constant partition walls overall. The blow molding method includes forming a preform having a receptacle divided by the partition wall, arranging the preform in a blowing mold and initially blow molding the same via a first blowing so as to impart a certain shape, and secondarily blow molding the resultant via a second blowing so as to impart a shape corresponding to that of the blowing mold.

### TECHNICAL FIELD

The present invention relates, in general, to a method of blow molding and manufacturing a container equipped with a divided receptacle.

More particularly, the present invention relates to a method of blow molding and manufacturing a container equipped with a receptacle divided by partition walls, wherein the partition walls are formed in a preform, which is in general fabricated by injection molding, the preform is arranged in a blow molding die, and blow molding is performed to the preform in a molding process which is conducted two times, so that a container product has constant partition walls overall.

The container includes many kinds of containers, such as a bottle type container, a neck of which is of a sectional area smaller than that of the receptacle, a container having an inlet larger than a body thereof, a container having a screw cap, a container having a one-touch cap, a container having an interference cap, a cylindrical container, a rectangular container, or the like.

Furthermore, the present invention relates to a container having an upper inlet of the divided receptacle which is able to be opened and closed by a single cap.

### BACKGROUND ART

As an example of a conventional container having a divided receptacle, reference can be made to “a container capable of separately storing heterogeneous liquids” disclosed in Korean Utility Model Registration No. 0060490 (Publication Date: Nov. 13, 1991).

The container having the divided receptacle is used in the case where different kinds of materials, such as a shampoo and rinse, or a hair dye and oxidizer, are discharged and mixed together via an outlet to be used, or where different kinds of foods such as cola and potato chips, cola and cider, kimchi and sliced kimchi, soybean paste and pepper paste, or the like, are stored in a single container according to a user's preference, so as to satisfy a demand of a consumer, and contribute to the creation of new demands.

The widely used synthetic resin container is manufactured by an injection molding method or a blow molding method.

Particularly, in the case of a bottle type container, a neck of which has a sectional area smaller than that of a receptacle thereof, it is common that a preform is injection-molded and processed with blow molding.

As an example of a duplex container manufactured by a conventional blowing method, a duplex container has been disclosed in Korean Patent Registration No. 0493424 (May 25, 2005) entitled “a transparent synthetic resinous duplex container and a manufacturing method thereof”. However, the duplex container is different from the present invention in that an outer cover of the conventional duplex container only has a duplex structure.

Further, there has also been a multiple container disclosed in Korean Unexamined Patent Publication No. 2006-0071954 (Jun. 27, 2006) entitled “a multiple container and a manufacturing method thereof”. However, since the multiple container is manufactured by the process of blow molding two cylindrical preforms, necks of which are connected together, it is different from the container of the invention in which a receptacle is divided by partition walls.

Furthermore, in the case of the multiple container of the publication, it is inconvenient to use because an inlet is opened and closed by two caps (especially, screw caps).

### DISCLOSURE OF INVENTION

### Technical Problem

Accordingly, the present invention has been made keeping in mind the above problems occurring in the related art, and is intended to provide a container and a blow molding method thereof in which an injection-molded preform having a partition wall in itself is provided, and the preform is loaded and molded in a blowing mold so as to have a receptacle divided by the partition wall, such that an intermediate form having a length corresponding to that of a container product is molded via a first blowing process, and the container product is finally molded via a second blowing process.

Further, the present invention serves to provide a container and a blow molding method thereof, wherein in the first blowing process, the container is stretched by a stretching rod together with expansion by blowing, wherein the number of the stretching rods corresponds to that of the divided spaces obtained by a partition wall so as to make sure that the container expands to have an overall uniform thickness.

Further, the present invention serves to provide a container and a blow molding method thereof, wherein the container is a kind of bottle, a neck of which has a sectional area smaller than a receptacle, wherein an upper end of the partition wall of the preform extends up to an upper end of the neck, and a body of a container product is provided with a fine separation line at an outer surface coming into contact with the partition wall.

### Technical Solution

In one aspect, the present invention provides a blow molding method for a container equipped with a divided receptacle, including the steps of: forming a preform having a receptacle divided by a partition wall; arranging the preform in a blowing mold and initially blow molding the same via a first blowing so as to impart a certain shape; and secondarily blow molding the resultant via a second blowing so as to impart a shape corresponding to that of the blowing mold.

In an embodiment, the first blow molding process may be implemented so that stretching is conducted by the introduction of the stretching rod into the neck of the container together with expansion by blowing.

In an embodiment, the number of the stretching rods may correspond to that of the divided spaces of the receptacle.

In an embodiment, a blowing pressure of the first blow molding process may be 7 to 11 kg/m², and a blowing pressure of the second blow molding process may be 20 to 40 kg/m².

In an embodiment, a container product may be of a shape of a bottle, the neck of which has a sectional area smaller than that of the receptacle, an upper end of a partition wall of the preform extends up to an upper end of the neck, and a body of the container product is provided with a fine separation line at an outer surface coming into contact with the partition wall.

### Advantageous Effects

As described above, in the container equipped with the divided receptacle and the blow molding method thereof according to the present invention, the injection-molded preform having the partition wall in itself is provided, and the preform is loaded and molded in the blowing mold so as to have the receptacle divided by the partition wall, such that the intermediate form having a length corresponding to that of a container product is molded via the first blowing process, and the container product is finally molded via the second blowing process.

The container having the divided receptacle is used in the case where different kinds of material, such as a shampoo and rinse, or a hair dye and oxidizer, are discharged and mixed together via an outlet to be used, or where different kinds of foods such as cola and potato chips, cola and cider, kimchi and sliced kimchi, soybean paste and pepper paste, or the like, are stored in a single container according to a user's preference, so as to satisfy a demand of a consumer, and contribute to the creation of new demands.

Further, although only a single cap (especially, a screw cap) is provided so as to open and close an inlet of the respective receptacles formed by a partitioning section of the container, a sufficient airtight feature is ensured, so that it is convenient to use.

Further, in the first blowing process, the container is stretched by the stretching rod together with expansion by blowing, such that the number of the stretching rods corresponds to that of the divided spaces obtained by the partition wall so as to make sure that the container expands to have a uniform thickness overall. Further, the container product has a shape of a bottle, the neck of which has a sectional area smaller than that of the receptacle.

### BRIEF DESCRIPTION OF THE DRAWINGS

FIG. 1 is a schematic partial cross-sectional view illustrating a mold for manufacturing a preform having a partition wall;

FIG. 2 is a schematic cross-sectional view illustrating the preform arranged in a blowing mold according to a blow molding method of the invention;

FIG. 3 is a schematic front cross-sectional view illustrating an intermediate form formed via a first blowing according to the blow molding method of the invention;

FIG. 4 is a schematic front cross-sectional view illustrating a container product formed via a second blowing according to the blow molding method of the invention;

FIG. 5 is a top cross-sectional view taken along line “C-C” of FIG. 4;

FIGS. 6 and 7 each illustrate a rectangular container having a one-touch cap and a cylindrical container having a large inlet and a screw cap; and

FIG. 8 is a schematic cross-sectional view illustrating a stretching procedure which is carried out by drawing means during formation of the intermediate form of FIG. 3.

### DESCRIPTION OF THE ELEMENTS IN THE DRAWINGS

B: Container P: Preform
M: Intermediate Form 10,10p,10m: Main Body
20,20p,20m: Mouth 30,30p,30m: Partition Wall
40: Mold 41: Body
43: Bottom Core 45: Stretching Rod
47: Blowing Core

### BEST MODE FOR CARRYING OUT THE INVENTION

Reference will now be made in greater detail to a preferred embodiment of the invention, an example of which is illustrated in the accompanying drawings. Wherever possible, if there is no special comment, the similar reference numerals will be used throughout the drawings and the description to refer to similar parts.

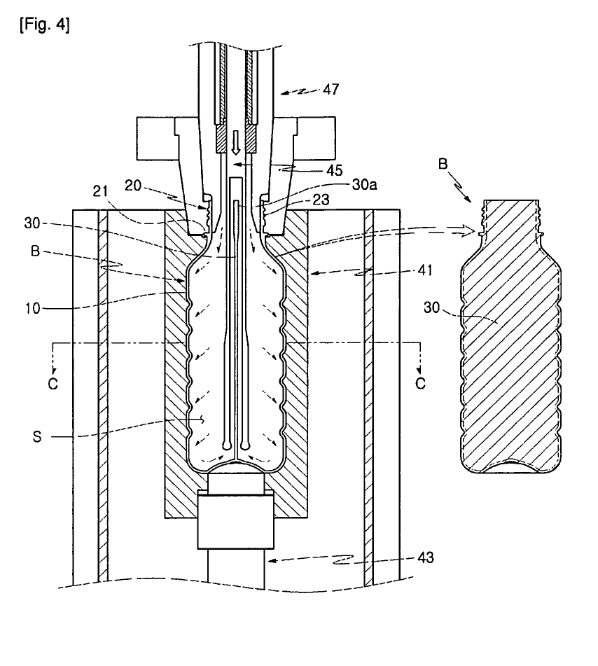

In describing the present invention, for convenience, it is defined that with reference to FIG. 4, an upward direction denotes a portion towards a neck 20 of a container product B, and a downward direction a portion opposite thereto.

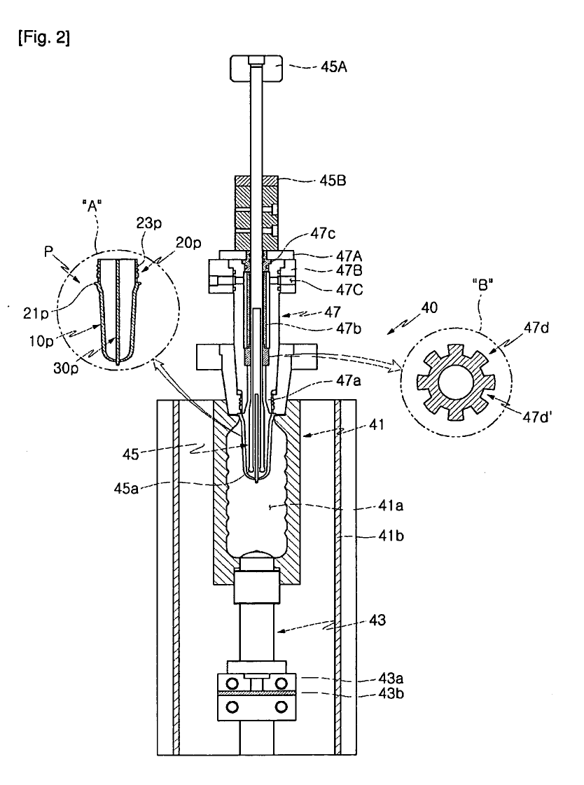

First, as illustrated in an enlarged circle “A” of FIG. 2, a preform, which is manufactured by a known injection molding process, includes a partition wall 30p, which is previously formed in a main body 10p. The container product B is of a shape of a bottle (See FIG. 4), the neck of which has a cross-sectional area smaller than that of a storing space, i.e. a receptacle. To this end, a mouth 20p of the container is previously provided with a threaded portion 23p and a flange 21p, which is fixedly engaged on an upper inlet of a cavity 41a of a body 41 of a blowing mold 40.

However, the present invention is not limited to the construction of the bottle type container (of the comparatively narrow neck, the threaded portion, and the flange).

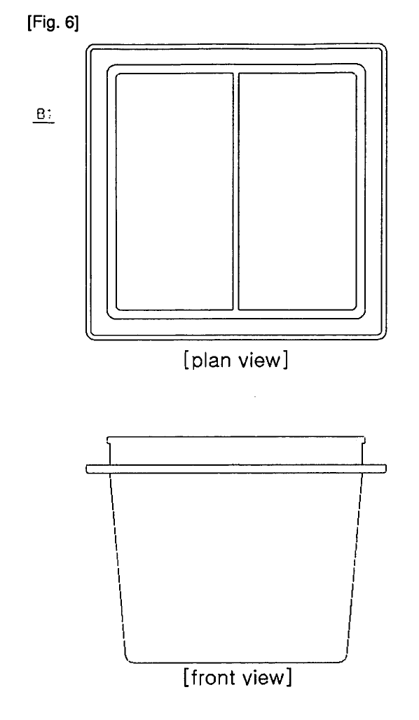

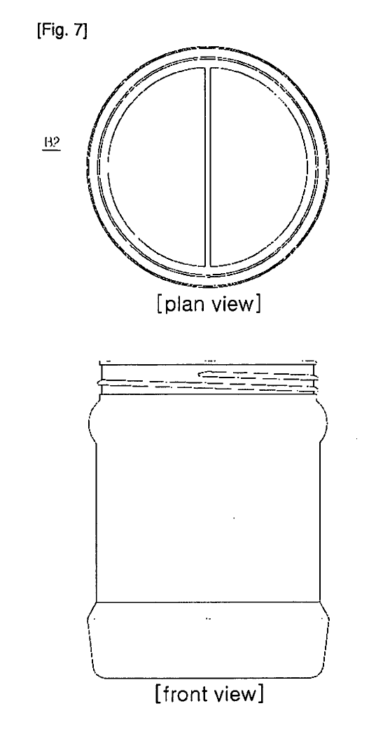

For example, the container of the invention may be a rectangular container B1 having a cap with a one-touch locking lever, as shown in the figures of FIG. 6 (a plan view and a front view), or a container B2 having a screw cap, in which a sectional area of an inlet of the neck is substantially identical to that of a receptacle thereof, as shown in the figures of FIG. 7 (a plan view and a front view).

However, the container of the invention may also be of various other shapes such as a triangle, an oval, or the like.

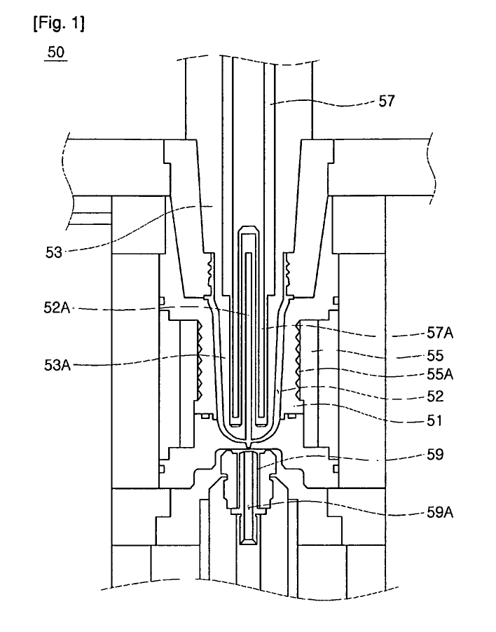

As illustrated in FIG. 1, a mold 50 for manufacturing the preform 10p includes an outer mold section 51, which is covered with a cooling cover 55 so as to form a coolant path 55A therebetween, and is provided to form an outer wall of a cavity 52 for the shape of the designed preform, a core 52 serving to form an inner wall of the cavity for the preform, a cooling pipe 57 for cooling the core 52, and a nozzle 59 having, on the lower side of the outer mold section 51, a path 59A for the injection of fused synthetic resin.

In order to construct the container to have the divided receptacle, it is preferred that the preform be provided with the partition wall, the core 53 have a partitioning section 53A for forming a cavity 52A corresponding to the partition wall, and the cooling pipe 57 mounted in the core 53 also having the same number of branches 57A, which can be provided in the respective partitioning sections 53A.

Referring to FIG. 2, the body 41 of the mold 40 consists of two halves and is covered with an insulating member 41b. The body 41 includes on a lower side thereof a bottom core 43 which is arranged on an upper portion of a fixing plate 43a and is covered with an insulating member 43b. Although not shown in the figure, the body 41 and the bottom core 43 are provided therein with a path for cooling water.

On the body 41, a blowing core 47 for blowing is put and is vertically movable by lifting/descending means (e.g. a hydraulic or pneumatic cylinder).

A lower contact tip 47a of the blowing core 47 is brought into contact with an inner surface of the neck 20p of the preform P, so that the blowing can be completely carried out without fluid leakage, which improves precise pressure control of blowing air.

A cover plate 47A on the blowing core 47 supports a stop block 45B for a stretching rod 45, and includes the fixing plate 47B thereunder, to which a blowing nozzle is fixed so as to blow air into an air inlet 47C provided on the blowing core 47.

The blowing core 47 is provided therein with a pipe 47b, through which the stretching rod 45 smoothly moves up and down along an inner circumferential face thereof, and along an outer circumferential face of which an air passage is formed.

A sealing bushing 47c is arranged around an upper portion of the pipe 47b.

As shown in an enlarged circle “B” of FIG. 2, on the lower portion of the pipe, grooves 47d′ are formed in which a bushing 47d is installed so as to inject air into the preform P via the grooves.

While the contact tip 47a of the blowing core 47, which is brought into contact with the neck 20p of the preform P, is an important element, the stretching rod 45 is considered as the most important element of the blowing mold 40.

As described below, during the first blow molding process, the stretching rod is intruded through the neck of the container together with expansion by blowing, allowing the preform to stretch.

Particularly, the stretching rods 45 are provided in a quantity corresponding to the number of the divided spaces of the receptacle (generally, two or three from a viewpoint of commercial use), and they are respectively intruded into the divided spaces, thereby ensuring uniform stretching.

Hereinafter, the blow molding process using the mold 40 will be described in detail with reference to the drawings.

In FIG. 1, as already mentioned before, the preform already includes the partition wall 30p, and is generally formed by an injection molding method. The mold for the preform may have many cavities for mass production.

The molding may be implemented by blow molding just after the preform molding, or the molding after the preform molding while differentiating the place and time therebetween. In the latter case, a reheating process using a lamp heater or other heater is required.

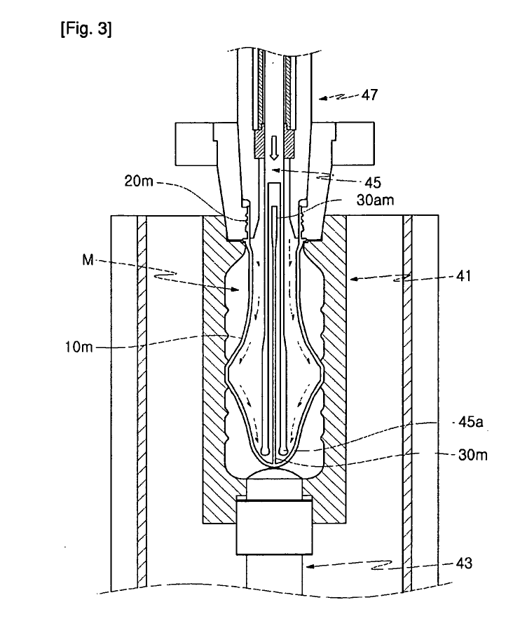

In the first blow molding process, when the flange 21p of the preform P is put on the upper portion of the mold body 41 so that the tip 47a of the blowing core 47 comes into contact with the inner surface of the neck 20p, as shown in FIGS. 2 and 3, the nozzle (not shown) which is connected to a compressor or the like, is fitted into the fixing plate 47B, so that injected air is forced to flow along the outer circumferential face of the pipe 47b of the blowing core and into the preform P through the grooves 47d′ of the bushing 47d so as to expand the preform P.

Herein, the stretching rod 45 moves downward along the inner circumferential face of the pipe 47b of the blowing core using the lifting/descending means, so as to press the bottom of the preform P causing it to stretch. This is a preferable process for the manufacture of a container having the constant thickness.

Further, the stretching rods are preferably provided as numerous members, which correspond to the number of the divided spaces of the receptacle of the preform, which are defined by the partition wall.

It is preferred that the temperature of the preform be maintained at 100 to 120° C. in the following second blow molding process as well as in the first blow molding process.

The neck portions 20p of the preform for the bottle type container (including the neck and the flange) have the same shape and size as those 20m and 20 of the intermediate form resulting from the first blow molding and the container product B resulting from the second blow molding, whereas the partition wall 30p is elongated and enlarged during the molding process from the preform to the container product.

Thus, if the partition wall 30p of the preform P extends up to the upper end of the neck 20p, as can be seen from FIG. 3, an upper end 30am of a partition wall 30m of the intermediate form M, which does not stretch during the first molding process, will be maintained thicker than the lower portion thereof.

The same case applies to an upper end 30a of a partition wall 30 of the container product B after the second molding process as shown in FIG. 4.

In FIG. 3, the intermediate form M obtained by the first blow molding process is stretched such that the length thereof is identical to that of the container product B obtained by the second blow molding process, and the middle portion of a body 10m thereof becomes expanded.

If the stretching rod 45 is not heated to the heated temperature of the preform by a separate heater, it is preferred that the rod does not come into contact with the preform P or the intermediate form M in order to prevent cooling.

Further, the tip 45a of the rod is preferably smooth and round so as to prevent breaking of the preform during stretching.

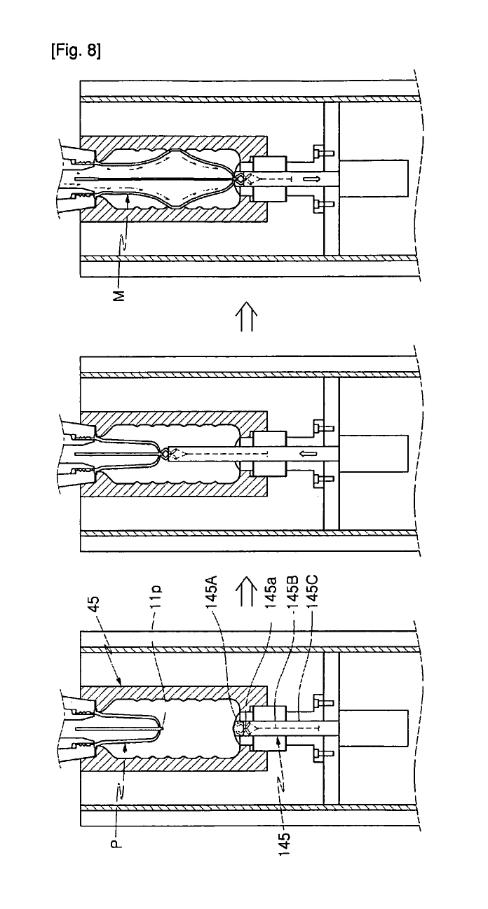

Instead of the stretching rod 45, which is of auxiliary use in stretching the preform during the first blow molding process shown in FIG. 3, illustrated in FIG. 8 is drawing means for drawing the lower portion of the preform so as to stretch the same.

Particularly, the drawing means includes a clamping member 145 for clamping a protrusion 11p provided on the lower portion of the preform P.

The shape of the protrusion of the preform may have diverse modified patterns, which allow for easy clamping by the clamping member and make sure that easy releasing from a mold for a preform is possible.

The clamping member 145 of the drawing means includes scissors 145A, which are pivoted about a hinge 145a so as to open and close, and a clamping rod 145B operating the scissors 145A.

The clamping member can be vertically moved by actuator means (not shown) for vertically moving a cover cylinder 145C, which is connected with the scissors 145A via the hinge 145a and covers the clamping rod 145B.

The construction for the operation of the clamping rod 145B may be embodied in diverse forms by those skilled in the art.

Although not shown in the drawing, the drawing means may include a suction member for vacuum-sucking the lower portion of the preform, and a lifting/descending member for moving a nozzle constituting the suction member. In this case, the protrusion of the preform may be eliminated.

Next, as shown in FIG. 4, the final secondary blow molding process is performed by air injection only, thereby producing a container conforming with the shape of a cavity 41a in the body 41 of the mold 40.

Since a blowing pressure of the first blow molding process is 7 to 11 kg/m², and a blowing pressure of the second blow molding process is 20 to 40 kg/m², the first blow molding process forms the intermediate form using smaller pressure (particularly, stretching the intermediate form to possibly have the length substantially identical to that of the container product), and the second blow molding process forms a final container product using greater pressure.

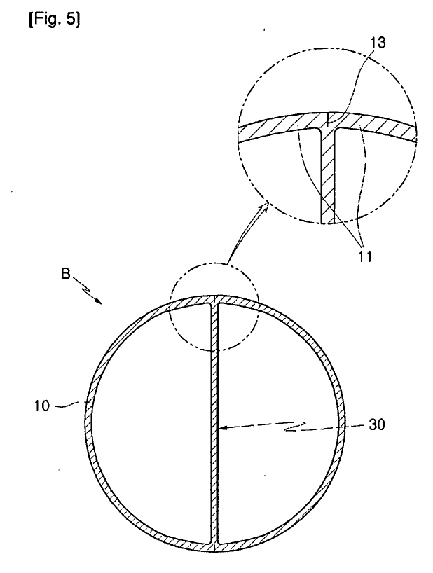

As shown in FIGS. 4 and 5, the container product B is of a shape of a bottle, the neck of which has a sectional area smaller than that of the receptacle S surrounded by the body 10, wherein the neck is provided on its outer circumferential face with a threaded portion 23 for screw-engagement with a cap.

The neck 20 and the flange 221 do not change in the slightest in either shape or size in the preform P and the intermediate form M (similarly to the upper end 30a of the partition wall to some extent).

On the contrary, the body 10 and the partition wall 30 (particularly, a portion underlying the upper end 30a) becomes elongated and enlarged, so that the thicknesses thereof become thinner than what they were in the preform (for convenience, a change in thickness during processes was not however illustrated in detail in FIGS. 1 to 4).

The inventor of the invention found that as compared to the conventional container, which was not processed with the first and second blow molding processes, in the case of the container of the present invention experiencing the two blowing processes, a straight, fine separation line 13 is provided on the outer circumferential face where the body 10 and the partition wall 30 are brought into contact with each other (which is illustrated in a slightly exaggerated manner in FIG. 5, which is a cross-sectional view cut along the line ‘C-C’ of FIG. 4).

It seems that this is caused from a stretching feature of synthetic resin which is in a mold, and it is expected that the separation line prevents breaking of the body 10 of the container B and the partition wall 30, thereby improving the durability of the container.

While the known technology concerning the molding method of the preform, the blow molding, the structures of the preform mold and the blowing mold, and the continuous molding processes from formation of the preform to the blow molding has been omitted in the description, it will be apparent to those skilled in the art.

Further, although in the drawings and specification, typical exemplary embodiments of the invention, e.g. a specified process, a specified mold structure, and a shape of the container (preform) have been disclosed, it is apparent that the embodiments may be changed and modified in diverse forms by those skilled in the art, and such changes and modifications should be construed to pertain to the scope of the invention being set forth in the following claims.

1-12. (canceled)

13. A blow-molded container comprising:
a main body having a receptacle;
a neck provided on an upper portion of the main body; and
a partition wall extending up to an upper end of the neck so as to divide the receptacle.

14. The blow-molded container according to claim 13, wherein the main body is provided with a fine separation line at an outer circumferential face coming into contact with the partition wall.

15. A blow molding method for a container equipped with a receptacle having divided spaces, comprising the steps of:
forming a preform having a receptacle divided by a partition wall;
arranging the preform in a blowing mold and initially blow molding the preform via a first blowing so as to impart an intermediate shape; and
secondarily blow molding the preform with the intermediate shape via a second blowing so as to impart a second shape corresponding to that of the blowing mold.

16. The blow molding method according to claim 15, wherein the first blow molding process uses stretching, conducted by the introduction of at least one stretching rod into a neck of the container, together with expansion by blowing.

17. The blow molding method according to claim 16, wherein there is one stretching rod for each divided space of the receptacle.

18. The blow molding method according to claim 15, wherein the first blow molding process uses a drawing means in the blowing mold for drawing a lower portion of the preform, to thereby stretch the preform while also expanding the preform by blowing.

19. The blow molding method according to claim 18, wherein the preform includes a holding protrusion, and the drawing means includes:
a clamping member for clamping the holding protrusion; and
a lifting/descending member for vertically moving the clamping member.

20. The blow molding method according to claim 18, wherein the drawing means includes a suction member for sucking the lower portion of the preform and a lifting/descending member for vertically moving the suction member.

21. The blow molding method according to claim 15, wherein a blowing pressure of the first blowing is 7 to 11 kg/cm², and a blowing pressure of the second blowing is 20 to 40 kg/cm².

22. The blow molding method according to claim 12, wherein the second shape is of a shape of a bottle, a neck of which has a sectional area smaller than that of the receptacle of the container which is below the neck.

23. The blow molding method according to claim 22, wherein an upper end of the partition wall of the preform extends up to an upper end of the neck.

24. The blow molding method according to claim 23, wherein a body of the container product is provided with a fine separation line at an outer circumferential face coming into contact with the partition wall.

25. The blow molding method according to claim 15, wherein the intermediate shape obtained by the first blowing has a length identical to that of the container.

26. The blow molding method according to claim 15, wherein a mold for the preform has a core equipped with a partitioning section so as to form a cavity corresponding to the shape of the preform having the receptacle divided by the partition wall, wherein the core is provided with a cooling pipe, which has branches identical in number to a number of the partitioning sections such that the branches are respectively provided in the partitioning sections.
